(19) United States
(12) Patent Application Publication
(10) Pub. No.: US 2022/0017261 A1
(43) Pub. Date: Jan. 20, 2022

(54) PACKING COMPONENT

(71) Applicant: Mitsubishi Electric Corporation, Tokyo (JP)

(72) Inventors: Takahiro KOMATSU, Tokyo (JP); Takaaki TAKISHITA, Tokyo (JP); Tetsuya TAZAWA, Tokyo (JP)

(21) Appl. No.: 17/295,595

(22) PCT Filed: Feb. 5, 2019
(86) PCT No.: PCT/JP2019/004005

§ 371 Date: May 20, 2021

(51) Int. Cl. B65D 5/42

(52) U.S. Cl. CPC B65D 5/4212

(57) ABSTRACT

A packing component includes a first outer packing part and a second outer packing part that define a box-like side wall. The first outer packing part includes a first side part, a first bend part, and a first joining part. The first side part defines a portion of an outer surface of the side wall. The first bend part is disposed along one edge of the first side part, and has a first identification part presenting information related to the first outer packing part. The first joining part is connected to the first side part across the first bend part. The second outer packing part is joined to the first joining part such that the second outer packing part is contiguous to the first bend part and the first side part. The second outer packing part has a second side part defining another portion of the outer surface of the side wall.

### TECHNICAL FIELD

The present disclosure relates to a packing component used to pack an object in the packing component.

### BACKGROUND ART

Patent Literature 1 discloses a packing component including outer packing parts defining a side wall, and flaps for closing the bottom portion of the packing component. Each flap is provided with an identification mark to identify whether the outer packing parts are joined incorrectly.

### CITATION LIST

### Patent Literature

Patent Literature 1: Japanese Unexamined Patent Application Publication No. 2005-212870

### SUMMARY OF INVENTION

### Technical Problem

Packing components such as one described in Patent Literature 1 are typically stored in a folded state to reduce the space required to accommodate the packing components. Such packing components as described in Patent Literature 1 are designed for storage and delivery in a folded and stacked state. The design of such packing components as described in Patent Literature 1 has a problem described below when the packing components undergo quality inspection in their stacked state. That is, as identification marks are provided on individual flaps, the identification marks become hidden and invisible in this state, except for only the identification mark on the uppermost packing component. For such packing components as described in Patent Literature 1, quality inspection of the packing components thus requires checking the identification mark of each of the stacked packing components in order from the identification mark on the uppermost packing component. This increases the workloads required for quality inspection.

The present disclosure is directed to addressing the above-mentioned problem, and it is thus an object of the present disclosure to provide a packing component designed to, even with a plurality of the packing components being in a folded and stacked state, allow for easy visual inspection of the quality of each packing component.

### Solution to Problem

A packing component according to an embodiment of the present disclosure includes a first outer packing part and a second outer packing part that define a box-like side wall. The first outer packing part includes a first side part, a first bend part, and a first joining part. The first side part defines a portion of an outer surface of the side wall. The first bend part is disposed along one edge of the first side part, and has a first identification part presenting information related to the first outer packing part. The first joining part is connected to the first side part across the first bend part. The second outer packing part is joined to the first joining part such that the second outer packing part is contiguous to the first bend part and the first side part. The second outer packing part has a second side part defining another portion of the outer surface of the side wall.

### Advantageous Effects of Invention

According to an embodiment of the present disclosure, even with a plurality of packing components being folded at their first bend parts and thus stacked in a folded state, the first identification part provided in the first bend part of each packing component is allowed to be easily checked visually. Thus, according to an embodiment of the present disclosure, quality inspection of such stacked packing components does not require checking the first identification part of each of the stacked packing components in order from the first identification mark of the uppermost packing component. This helps to reduce the workloads required for quality inspection. As described above, an embodiment of the present disclosure makes it possible to provide a packing component designed such that, even with a plurality of the packing components being in a folded and stacked state, the quality of each packing component is allowed to be easily inspected visually.

### BRIEF DESCRIPTION OF DRAWINGS

FIG. 1 is a perspective view of a packing component according to an embodiment of the present disclosure, schematically illustrating an exemplary outward appearance of the packing component.

FIG. 2 is a developed plan view of a first outer packing part of the packing component according to the embodiment of the present disclosure, schematically illustrating the structure of the first outer packing part.

FIG. 3 is a developed plan view of a second outer packing part of the packing component according to the embodiment of the present disclosure, schematically illustrating the structure of the second outer packing part.

FIG. 4 is a schematic perspective view of the packing component according to the embodiment of the present disclosure in a pre-folded state.

FIG. 5 schematically illustrates the packing component according to the embodiment of the present disclosure in a folded state, as the packing component is viewed toward a first bend part.

FIG. 6 schematically illustrates an example of a plurality of the packing components according to the embodiment of the present disclosure in a folded and stacked state, as the packing components are viewed toward the first bend parts.

FIG. 7 schematically illustrates another example of a plurality of the packing components according to the embodiment of the present disclosure in a folded and stacked state, as the packing components are viewed toward the first bend parts.

### DESCRIPTION OF EMBODIMENTS

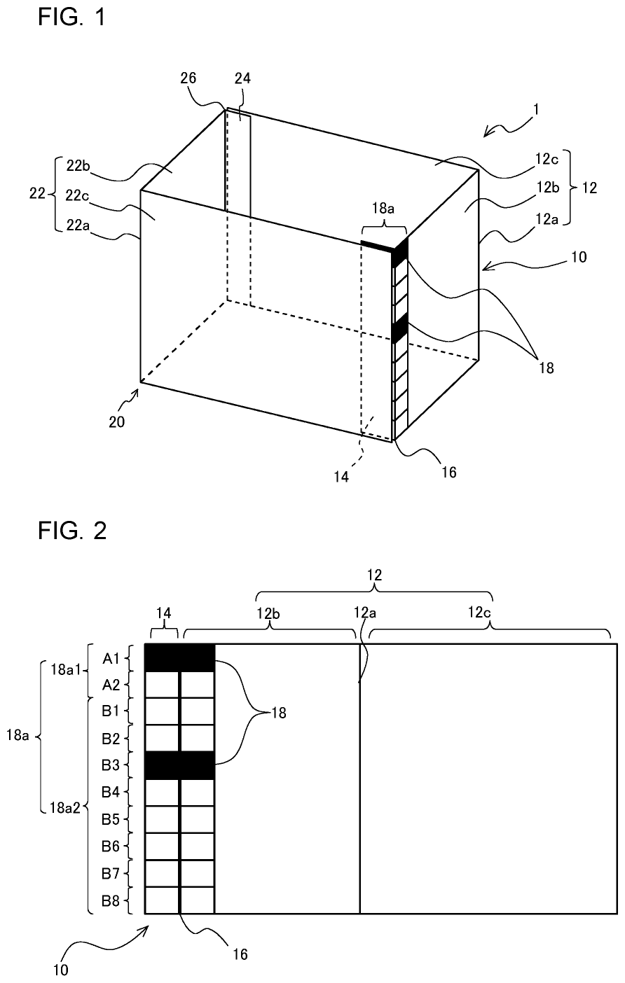

A packing component 1 according to an embodiment of the present disclosure is described below. FIG. 1 is a perspective view of the packing component 1 according to the embodiment, schematically illustrating an exemplary outward appearance of the packing component 1. In the figures below including FIG. 1, the relative dimensions and shapes of various component parts of the packing component 1 may differ from the actuality. In the figures below including FIG. 1, identical parts or portions, or parts or portions having the same function are designated by the same reference signs, or their reference signs are omitted.

When the packing component 1 is used for packing a large object in the packing component 1, such as an air-conditioning apparatus, the packing component 1 is formed by a combination of two or more outer packing parts. In FIG. 1, the packing component 1 includes a first outer packing part 10, and a second outer packing part 20. The first outer packing part 10 and the second outer packing part 20 define a box-like side wall.

The first outer packing part 10 includes a first side part 12 defining a portion of the outer surface of the box-like side wall, a first bend part 16 disposed along one edge of the first side part 12, and a first joining part 14 connected to the first side part 12 across the first bend part 16. That is, the first bend part 16 is an area connecting the first side part 12 and the first joining part 14. The first side part 12 is allowed to have a first fold 12a extending in the same direction as the longitudinal direction of the first bend part 16. By folding the first side part 12 at the first fold 12a, the first side part 12 is allowed to be divided into a first decorative surface 12b and a second decorative surface 12c. Decoration is allowed to be applied by printing or other methods to the first decorative surface 12b and the second decorative surface 12c to present various information about an object being packed in the packing component 1, the various information being directed to an end user such as a consumer and an on-site worker.

The second outer packing part 20 has a second side part 22 defining the other portion of the outer surface of the box-like side wall. The second outer packing part 20 is allowed to have a second bend part 26 disposed along one edge of the second side part 22, and a second joining part 24 connected to the second side part 22 across the second bend part 26. The second bend part 26 is an area connecting the second side part 22 and the second joining part 24. The second side part 22 is allowed to have a second fold 22a extending in the same direction as the longitudinal direction of the second bend part 26. By folding the second side part 22 at the second fold 22a, the second side part 22 is allowed to be divided into a third decorative surface 22b and a fourth decorative surface 22c. As with the first decorative surface 12b and the second decorative surface 12c, decoration is allowed to be applied by printing or other methods to the third decorative surface 22b and the fourth decorative surface 22c to present various information about an object being packed in the packing component 1, the various information being directed to an end user such as a consumer and an on-site worker.

The second outer packing part 20 is joined to the first outer packing part 10, Specifically, the second outer packing part 20 is joined to the first joining part 14 such that the second outer packing part 20 is contiguous to the first bend part 16 and the first side part 12 of the first outer packing part 10. By joining and assembling the first outer packing part 10 and the second outer packing part 20 together, a space for accommodating an object to be packed is created, the space being bounded by the first decorative surface 12b and the second decorative surface 12c of the first outer packing part 10 and by the third decorative surface 22b and the fourth decorative surface 22c of the second outer packing part 20. In FIG. 1, the first joining part 14 of the first outer packing part 10 is joined to the second side part 22 of the second outer packing part 20. The second joining part 24 of the second outer packing part 20 is joined to the first side part 12 of the first outer packing part 10. The joining is done, for example, by adhesive application or by stapling.

The packing component 1 may not necessarily have the above-mentioned structure. In one example, the packing component 1 may be made up of two first outer packing parts 10, which define a box-like side wall. In this case, the packing component 1 can be formed by a combination of identical parts, leading to reduced manufacturing workloads. In another example, the second outer packing part 20 of the packing component 1 may be integrated with the first outer packing part 10. In other words, the second side part 22 of the second outer packing part 20 may be integrated with the first side part 12 of the first outer packing part 10. By integrating the second side part 22 of the second outer packing part 20 with the first side part 12 of the first outer packing part 10, the packing component 1 can be formed not to have the second joining part 24 and the second bend part 26.

The packing component 1 may include a flap part or flap parts provided to the first side part 12 of the first outer packing part 10 and to the second side part 22 of the second outer packing part 20 to close off the internal space of the packing component 1 in its assembled state from one side or from both sides.

The structure of the first outer packing part 10 of the packing component 1 according to the embodiment of the present disclosure is described below with more detail with reference to FIG. 2. FIG. 2 is a developed plan view of the first outer packing part 10 of the packing component 1 according to the embodiment, schematically illustrating the structure of the first outer packing part 10. The first outer packing part 10 can be formed by, for example, a punching process that involves punching of a packing material such as a corrugated cardboard with a wooden die or a metal die.

As described above, the first outer packing part 10 includes the first side part 12, the first joining part 14 disposed along one edge of the first side part 12, and the first bend part 16, which connects the first side part 12 with the first joining part 14. The first bend part 16 is, as described above, an area connecting the first side part 12 and the first joining part 14, and includes a first identification part 18, which presents information related to the first outer packing part 10.

The first identification part 18 is disposed in, for example, a plurality of first identification information regions 18a disposed to extend across the first joining part 14 and the first bend part 16. The first identification information regions 18a can be partitioned by, for example, printing of a grid. With the above configuration, the first identification part 18 is disposed in the first joining part 14. A worker assembling the packing component 1 is thus allowed to easily see the first identification part 18 when joining the second outer packing part 20 to the first joining part 14. The above configuration therefore helps to reduce the workloads for checking performed during assembly, and to reduce operational mistakes such as erroneous installation of parts.

As illustrated in FIG. 2, the first identification part 18 is allowed to be disposed in the first identification information regions 18a, which are disposed to extend across the first joining part 14, the first bend part 16, and a portion of the first side part 12. This configuration ensures that the first identification part 18 is disposed in a portion of the first side part 12, which allows a packing worker to easily see the first identification part 18 when putting, into the packing component 1, an object to be packed in the packing component 1. The above configuration therefore helps to reduce the workloads required for checking performed during packing, and to reduce, for example, packing mistakes.

In the first identification part 18, information related to the first outer packing part 10, such as the kind of an object being packed in the packing component 1, is allowed to be presented in at least one of the first identification information regions 18a by a color, a pattern, or a combination of a color and a pattern. FIG. 2 illustrates an exemplary case where, of the first identification information regions 18a, a region A1 and a region B3 are colored. Examples of patterns that may be used for the first identification part 18 include a fill pattern, a dot pattern, and a hatch pattern.

A character or a number is allowed to be added to the first identification information regions 18a. For the first outer packing part 10, a number or a character may be printed on all of the first identification information regions 18a, and by determining where a color or other feature is added, information related to the first outer packing part 10 may be easily identified. For example, the first outer packing part 10 may have a character or number printed in a light color such as white on the first identification information region 18a that bears a dark color such as black or other feature, so that by determining where a color or other feature is added, information related to the first outer packing part 10 may be easily identified.

The first identification information regions 18a may be divided into a plurality of groups of identification information in the longitudinal direction of the first bend part 16 to allow for identification of different pieces of information. For example, the first identification information regions 18a is allowed to be divided into a first region 18a1 for identifying the first outer packing part 10 and the second outer packing part 20 from each other, and a second region 18a2 for identifying information related to the first outer packing part 10, such as the kind of an object being packed in the packing component 1, For example, the first region 18a1 is illustrated in FIG. 2 as further having regions A1 and A2. The second region 18a2 is illustrated in FIG. 2 as further having regions B1 to B8. By dividing the first identification information regions 18a into groups of identification information in this way, the amount of identifiable information related to the packing component 1 is allowed to be increased.

The structure of the second outer packing part 20 of the packing component 1 according to the embodiment of the present disclosure is described below with more detail with reference to FIG. 2. FIG. 2 is a developed plan view of the second outer packing part 20 of the packing component 1 according to the embodiment, schematically illustrating the structure of the second outer packing part 20. As with the first outer packing part 10, the second outer packing part 20 can be formed by, for example, a punching process that involves punching of a packing material such as a corrugated cardboard with a wooden die or a metal die. As described above, the packing component 1 may not include the second outer packing part 20 but may be made up of two first outer packing parts 10, which define a box-like side wall.

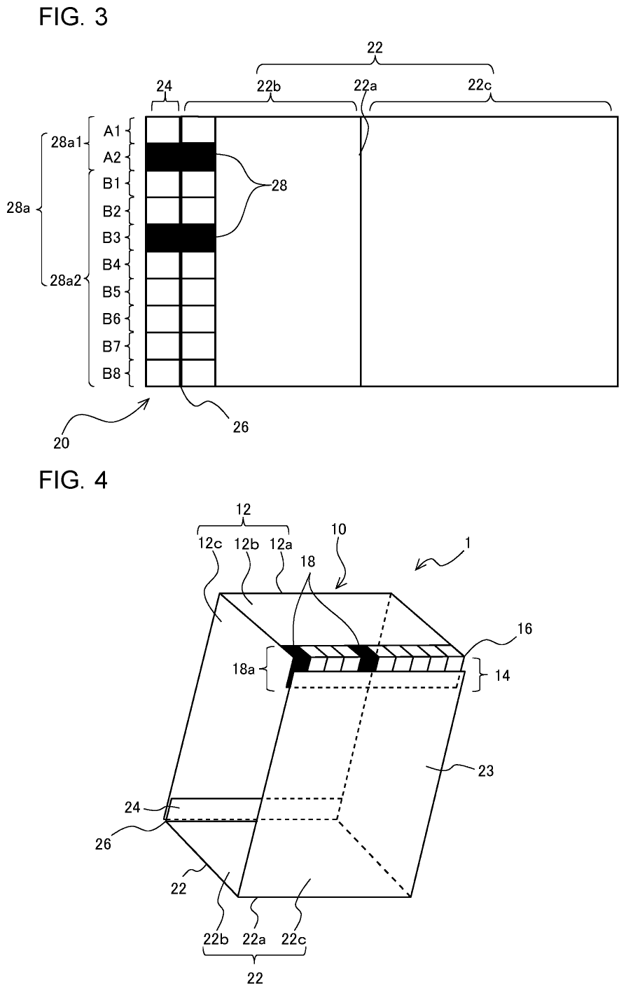

As described above, the second outer packing part 20 has the second side part 22 contiguous to the first side part 12. Further, as illustrated in FIG. 3, the second outer packing part 20 is allowed to have the second bend part 26 disposed along one edge of the second side part 22, and the second joining part 24 connected to the second side part 22 across the second bend part 26. The second bend part 26 of the second outer packing part 20 is, as described above, an area connecting the second side part 22 and the second joining part 24, and is allowed to have a second identification part 28, which presents information related to the second outer packing part 20. As described above, when the second side part 22 of the second outer packing part 20 is integrated with the first side part 12 of the first outer packing part 10, the packing component 1 does not include the second joining part 24 and the second bend part 26. When the second side part 22 of the second outer packing part 20 is integrated with the first side part 12 of the first outer packing part 10, the packing component 1 can therefore be formed not to have the second identification part 28.

The second identification part 28 may be disposed in, for example, a plurality of second identification information regions 28a disposed to extend across the second joining part 24 and the second bend part 26. The first identification information regions 18a can be partitioned by, for example, printing of a grid. With the above configuration, the second identification part 28 is disposed in the second joining part 24. A worker assembling the packing component 1 is thus allowed to easily see the second identification part 28 when joining the first outer packing part 10 to the second joining part 24. The above configuration therefore helps to reduce the workloads for checking performed during assembly, and to reduce operational mistakes such as erroneous installation of parts.

As illustrated in FIG. 3, the second identification part 28 is allowed to be disposed in the second identification information regions 28a, which are disposed to extend across the second joining part 24, the second bend part 26, and a portion of the second side part 22. This configuration ensures that the second identification part 28 is disposed in a portion of the second side part 22, which allows a packing worker to easily see the second identification part 28 when putting, into the packing component 1, an object to be packed in the packing component 1. The above configuration therefore helps to reduce the workloads required for checking performed during packing, and to reduce, for example, packing mistakes.

In the second identification part 28, information related to the second outer packing part 20, such as the kind of an object being packed in the packing component 1, is allowed to be presented in at least one of the second identification information regions 28a by a color, a pattern, or a combination of a color and a pattern. FIG. 3 illustrates an exemplary case where, of the second identification information regions 28a, a region A2 and a region B3 are colored. Examples of patterns that may be used for the second identification part 28 include a fill pattern, a dot pattern, and a hatch pattern. A color, a pattern, or a combination of a color and a pattern presented in at least one of the second identification information regions 28a is allowed to be made to differ from a color, a pattern, or a combination of a color and a pattern presented in at least one of the first identification information regions 18a. This configuration allows for easy visual confirmation of the difference between information presented on the first outer packing part 10 and information presented on the second outer packing part 20. The above configuration also increases the variety of information to be presented on the first outer packing part 10 and the second outer packing part 20, thus allowing for increased amount of information provided about the packing component 1.

A character or a number is allowed to be added to the second identification information regions 28a. For the second outer packing part 20, a number or a character may be printed on all of the second identification information regions 28a, and by determining where a color or other feature is added, information related to the second outer packing part 20 may be easily identified. For example, the second outer packing part 20 may have a character or number printed in a light color such as white on the second identification information region 28a that bears a dark color such as black or other feature, so that by determining where a color or other feature is added, information related to the second outer packing part 20 may be easily identified.

As illustrated in FIG. 3, the second identification information regions 28a may be divided into a plurality of groups of identification information in the longitudinal direction of the second bend part 26 to allow for identification of different pieces of information. For example, the second identification information regions 28a is allowed to be divided into a third region 28a1 for identifying the first outer packing part 10 and the second outer packing part 20 from each other, and a fourth region 28a2 for identifying information related to the second outer packing part 20, such as the kind of an object being packed in the packing component 1. For example, the third region 28a1 is illustrated in FIG. 3 as further having regions A1 and A2. The fourth region 28a2 is illustrated in FIG. 3 as further having regions B1 to B8. By dividing the second identification information regions 28a into groups of identification information in this way, the amount of identifiable information related to the packing component 1 is allowed to be increased.

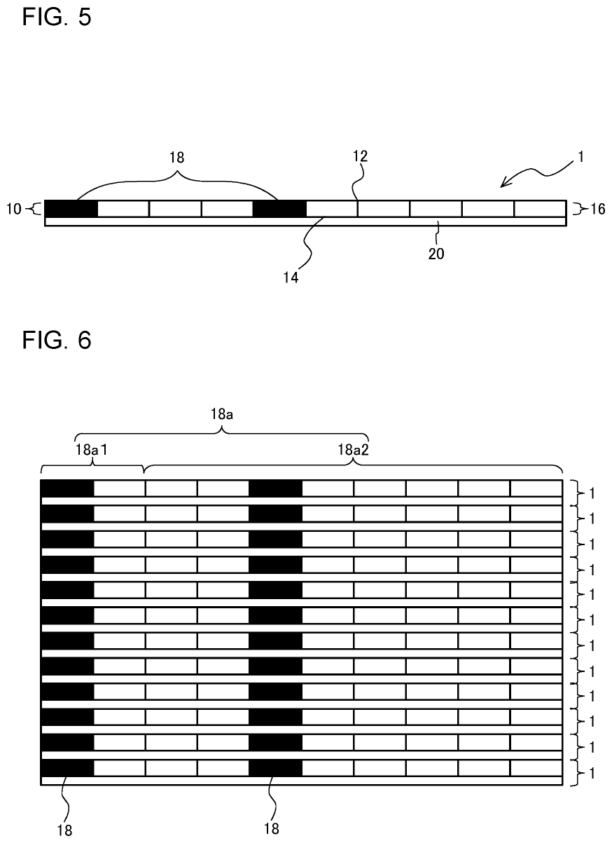

The structure of the packing component 1 according to the embodiment in a folded state is described below with reference to FIGS. 4 and 5. FIG. 4 is a schematic perspective view of the packing component 1 according to the embodiment in a pre-folded state. FIG. 5 schematically illustrates an example of the packing component 1 according to the embodiment in a folded state, as the packing component 1 is viewed toward the first bend part 16.

As illustrated in FIGS. 4 and 5, the packing component 1 is folded at the first bend part 16 of the first outer packing part 10 and at the second bend part 26 of the second outer packing part 20 for storage in a flat condition such that the first identification part 18 is at least visible. As illustrated in FIG. 5, with the packing component 1 in a folded state, the first identification part 18 is visible when the packing component 1 is seen toward the first bend part 16 of the first outer packing part 10. The packing component 1 is illustrated in FIG. 5 as being disposed in a folded state such that the first side part 12 of the first outer packing part 10 is located at the top and the second side part 22 of the second outer packing part 20 is located at the bottom. However, the packing component 1 may not necessarily be disposed as illustrated in FIG. 5 in its folded state. Alternatively, the packing component 1 may be disposed such that the second side part 22 of the second outer packing part 20 is located at the top and the first side part 12 of the first outer packing part 10 is located at the bottom.

FIG. 6 schematically illustrates an example of a plurality of the packing components 1 according to the embodiment in a folded and stacked state, as the packing components 1 are viewed toward the first bend parts 16. FIG. 6 illustrates a plurality of the packing components 1 of the same kind as the packing component 1 illustrated in FIG. 5, the packing components 1 being stacked on top of each other with the first side part 12 of each first outer packing part 10 facing up and with the first bend part 16 of each first outer packing part 10 facing in the same direction. To reduce the required accommodation space for such packing components 1, the packing components 1 are stacked on top of each other as illustrated in FIG. 6 for storage and transport.

As illustrated in FIG. 6, the state is easily observed where, with a plurality of the packing components 1 of the same kind as the packing component 1 in FIG. 5 being stacked on top of each other without any error in the direction of their stacking, the first identification parts 18 of the stacked packing components 1 are all in alignment with each other as the packing components 1 are viewed toward the first bend parts 16.

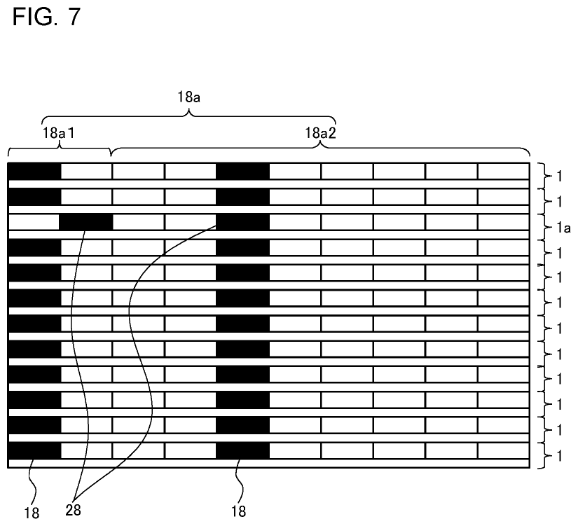

FIG. 7 schematically illustrates another example of a plurality of the packing components 1 according to the embodiment in a folded and stacked state, as the packing components 1 are viewed toward the first bend parts 16. FIG. 7 illustrates a plurality of the packing components 1 stacked up together with a packing component 1a, which is different from the packing component 1 illustrated in FIG. 5. FIG. illustrates an exemplary case where the packing component 1a, which is formed by joining two second outer packing parts 20 and different from the packing components 1, is stacked together with the packing components 1.

As illustrated in FIG. 7, when the packing component 1a different from the packing components 1 is stacked with the second identification parts 28 of the packing component 1a facing in the same direction as the first identification part 18 of each packing component 1, first identification parts 18 and one of the second identification parts 28 are positioned in different lines as the packing component 1a and the packing components 1 are viewed toward the first bend parts 16. Thus, in FIG. 7, first identification parts 18 and one of the second identification parts 28 are not in alignment with each other.

In FIGS. 6 and 7, as the first identification part 18 is provided in the first bend part 16 of the first outer packing part 10 of the packing component 1, even with a plurality of the packing components 1 stacked in a folded state, visual confirmation is easy on whether no packing component 1a different from the packing components 1 is mixed in the stack. Even with such packing components 1 stacked in a folded state, visual identification is thus easy on whether the packing component 1a different from the packing components 1, for example, a detective packing component, is mixed in the stack. Further, with the above-mentioned configuration of the packing component 1, quality inspection on a plurality of the packing components 1 in their stacked state is performed without the need to check the first identification part 18 of each of the stacked packing components 1 in order from the first identification part 18 of the uppermost packing component 1. This helps to reduce the workloads required for quality inspection at the time of shipping, delivery, or stored-object confirmation of the packing components 1. As described above, as the first identification part 18 is provided in the first bend part 16 of the first outer packing part 10 of the packing component 1, even with a plurality of the packing components 1 stacked in a folded state, the quality of each packing component 1 is allowed to be easily inspected visually.

When the first identification information regions 18a are divided into a plurality of groups of identification information as described above, the first bend part 16 is supposed to have a plurality of first identification parts 18. Thus, dividing the first identification information regions 18a into a plurality of groups of identification information makes it possible, even with a plurality of the packing components 1 stacked in a folded state, to visually identify a plurality of pieces of different information related to the packing component 1. For example, as illustrated in FIGS. 2 and 6, the first identification information regions 18a disposed in the first bend part 16 is allowed to be divided into the first region 18a1 and the second region 18a2. With this configuration, as the first identification part 18 is provided in each of the first region 18a1 located in the first bend part 16 and the second region 18a2 located in the first bend part 16, a plurality of pieces of different information is allowed to be visually identified.

### REFERENCE SIGNS LIST

1: packing component, 1a: different packing component, 10: first outer packing part, 12: first side part, 12a: first fold, 12b: first decorative surface, 12c: second decorative surface, 14: first joining part, 16: first bend part, 18: first identification part, 18a: first identification information region, 18a1: first region, 18a2: second region, 20: second outer packing part, 22: second side part, 22a: second fold, 22b: third decorative surface, 22c: fourth decorative surface, 24: second joining part, 26: second bend part, 28: second identification part, 28a: second identification information region, 28a1: third region, 28a2: fourth region, A1, A2, B1, B2, B3, B4, B5, B6, B7, B8: region

1. A packing component comprising:
a first outer packing part; and
a second outer packing part,
the first outer packing part and the second outer packing part defining a box-like side wall,
the first outer packing part including
a first side part defining a portion of an outer surface of the box-like side wall,
a first bend part disposed along one edge of the first side part and having a first identification part, the first identification part presenting information related to the first outer packing part, and
a first joining part connected to the first side part across the first bend part,
the second outer packing part being joined to the first joining part such that the second outer packing part is contiguous to the first bend part and the first side part,
the second outer packing part including a second side part, the second side part defining an other portion of the outer surface of the box-like side wall,
the first identification part being disposed in a plurality of first identification information regions, the plurality of first identification information regions being disposed to extend across the first joining part, the first bend part, and a portion of the first side part.

2-3. (canceled)

4. The packing component of claim 1, wherein, as the first identification part, the information related to the first outer packing part is presented in at least one of the plurality of first identification information regions by a color, a pattern, or a combination of a color and a pattern.

5. The packing component of claim 1, wherein a character or a number is added to the plurality of first identification information regions.

6. The packing component of claim 1, wherein the second side part is integrated with the first side part.

7. (canceled)

8. The packing component of claim 1, wherein the second outer packing part further includes
a second bend part disposed along one edge of the second side part and having a second identification part, the second identification part presenting information related to the second outer packing part, and
a second joining part connected to the second side part across the second bend part.

9. The packing component of claim 8, wherein the second identification part is disposed in a plurality of second identification information regions, the plurality of second identification information regions being disposed to extend across the second joining part and the second bend part.

10. The packing component of claim 8, wherein the second identification part is disposed in a plurality of second identification information regions, the plurality of second identification information regions being disposed to extend across the second joining part, the second bend part, and a portion of the second side part.

11. The packing component of claim 9, wherein, as the first identification part, the information related to the first outer packing part is presented in at least one of the plurality of first identification information regions by a color, a pattern, or a combination of a color and a pattern.

12. The packing component of claim 11, wherein, as the second identification part, the information related to the second outer packing part is presented in at least one of the plurality of second identification information regions by a color, a pattern, or a combination of a color and a pattern.

13. The packing component of claim 12, wherein the color, the pattern, or the combination of a color and a pattern added to the at least one of the plurality of second identification information regions differs from the color, the pattern, or the combination of a color and a pattern added to the at least one of the plurality of first identification information regions.

14. The packing component of claim 9, wherein a character or a number is added to the plurality of first identification information regions.

15. The packing component of claim 14, wherein a character or a number is added to the plurality of second identification information regions.
